(19) United States
(12) Patent Application Publication
(10) Pub. No.: US 2021/0135173 A1
(43) Pub. Date: May 6, 2021

(54) BATTERY MODULES AND SYSTEMS HAVING A PLURALITY OF GRAPHITE, SILICON AND/OR SILICON OXIDE CELLS AND A (LITHIUM) TITANATE OXIDE CELL

(71) Applicant: SAFT AMERICA, Cockeysville, MD (US)

(72) Inventors: Saori TOKUOKA, Cockeysville, MD (US); Thomas GRESZLER, Cockeysville, MD (US); James G. SNYDER, Cockeysville, MD (US)

(73) Assignee: SAFT AMERICA, Cockeysville, MD (US)

(21) Appl. No.: 16/668,927

(22) Filed: Oct. 30, 2019

(51) Int. Cl. H01M 2/10; H01M 4/36; H01M 4/485; H01M 4/505; H01M 4/525; H01M 4/58; H01M 4/587; H01M 10/0525; H01M 10/48

(52) U.S. Cl. CPC H01M 2/1016; H01M 4/364; H01M 4/485; H01M 4/505; H01M 10/482; H01M 4/5825; H01M 4/587; H01M 10/0525; H01M 4/525

(57) ABSTRACT

Provided are battery modules having two different types electrochemistry connected in series, which includes a plurality of a first cell, wherein the first cell includes an anode active material of graphite, Si, SiOx, or a blend thereof as a main component (“a GSi cell”), and at least one of a second cell, wherein the second cell includes an anode active material of a lithium titanate oxide or titanate oxide able to be lithiated as a main component (“a LTO cell”). Also provided are battery systems that include a plurality of the battery modules.

### BACKGROUND

### Technical Field

The present disclosure presents improvements to battery modules that contain a plurality of electrochemical cells having a graphite-, Si-, and/or SiOx-based anode material, and improvements to battery systems that include a plurality of the battery modules. In particular, the present disclosure is directed to battery modules and systems that provide one or more benefits, which include improved safety, improved robustness, and improved capabilities for a battery management system, such as improved determination of state of charge (SoC).

### Description of Related Art

Graphite is a widely used anode material for lithium ion cells. One reason is that a graphite anode provides a high cell voltage because graphite can go to a low voltage, i.e., nearly 0V versus Li metal. However, fully charged graphite acts like lithium metal and is very reactive. The high voltage and high reactivity of a graphite anode cell are primary reasons why fully charged lithium ion batteries often fail abuse tests, such as an over charge test, a nail penetration test, an impact test, a drop test, etc.

Abuse tests for cells using a silicon-based anode material of Si, SiOx or a blend thereof are typically even more difficult to pass than for graphite cells due to their higher capacity and large volume expansion during cycling. Furthermore, a very large anode surface area, and a reactive solid electrolyte interface (or SEI) formed thereon, make it even more difficult for batteries having a silicon-based anode material to pass abuse tests.

In contrast, an anode material of a lithium titanate oxide compound or a titanate oxide compound able to be lithiated (for convenience such compounds are referred to herein in combination as “LTO”) has a high minimum voltage, i.e., 1.5V versus Li metal. Thus, LTO cell voltage is 1.5V lower than for a graphite cell. In addition, fully charged LTO is chemically stable. Down to low cell voltage and chemical stability, LTO anode cells shows very good abuse test stability, typically not causing a fire.

The state of charge (or SoC) of a battery system is most easily determined based on cell voltage. However, certain advantageous electrochemical couples (i.e., anode material/cathode material) have a very flat voltage during charge and discharge, such as graphite, Si, SiOx, or blends thereof based electrochemical couples, making it nearly impossible to determine SoC based on cell voltage. In particular, electrochemical couples of graphite, Si, SiOx, or blend thereof as an anode material paired with a lithiated phosphate cathode material, e.g., graphite/LiFePO₄, exhibit a very flat voltage during charge and discharge. This is shown, for example, by the voltage versus depth of discharge (DOD) curve in FIG. 4. The typical solution for this issue is to carefully measure battery current and constantly integrate the measured current versus time, in a Coulomb counting process. However, the range of current to be measured presents a challenge due to error accumulation in the integrated value. Furthermore, batteries capable of supplying 2000 Amperes can be completely discharged by loads of 0.1 Ampere over the span of one month. Since it is not presently practical to achieve 0.1 A accuracy on a current measurement system with a 2000 A range, SoC uncertainty can increase at a rate of at least 25% per week.

Accordingly, there is still a need for battery modules and battery systems that contain a plurality of cells having a graphite, Si, SiOx, or blend thereof anode material that are robust, safe and/or can be easily managed by a battery management system (e.g., easy and accurate detection of SoC).

### SUMMARY OF THE DISCLOSURE

The embodiments of the present disclosure provide improved battery modules and battery systems that address the technical problems noted above pertaining to modules that contain a plurality of cells having graphite, Si, SiOx, or a blend thereof as an anode active material (i.e., negative electrode active material). In particular, the embodiments of the present disclosure provide a battery module that further includes at least one cell with a lithium titanate oxide or titanate oxide able to be lithiated as an anode material, which is connected in series to the graphite/Si/SiOx cells. According to these embodiments, cells of these two different electrochemistries are connected in series to provide one or more of benefits, such as improved safety, improved robustness, and improved determination of state of charge.

According to a first exemplary embodiment of the present disclosure, a battery module is provided that includes: a first cell including a first cell anode having a first cell anode active material, and a first cell cathode having a first cell cathode active material, wherein at least 60 wt % of the first cell anode active material is graphite, silicon, SiOx, or a blend thereof when an entire content of the first cell anode active material is considered 100 wt %; and a second cell including a second cell anode having a second cell anode active material, and a second cell cathode having a second cell cathode active material, wherein at least 60 wt % of the second cell anode active material is a lithium titanate oxide or titanate oxide able to be lithiated when an entire content of the second cell anode active material is considered 100 wt %. In the first exemplary embodiment, the battery module includes a plurality of the first cell and at least one of the second cell, and the at least one second cell is electrically connected in series to the plurality of the first cell. In the first exemplary embodiment, the lithium titanate oxide or titanate oxide able to be lithiated is a compound according to one of the following formulas (1) to (5) or a blend thereof:

Liₓ₋ₐAₐTi_{y-b}B_{b}O_{4-c-d}C_{c} formula (1),

wherein, in formula (1): 0.5<=x<=3; 1<=y<=2.5; 0<=a<=1; 0<=b<=1; 0<=c<=2; −2.5<=d<=2.5, A is at least one selected from Na, K, Mg, Ca, Cu or La; B is at least one selected from Mo, Mn, Ce, Sn, Zr, Si, W, V, Ta, Sb, Nb, Fe, Co, Ni, Zn, Al, Cr, La, Pr, Bi, Sc, Eu, Sm, Gd, Ti, Ce or Eu; and C is at least one selected from F, S or Br,

HₓTi_{y}O₄ formula (2),

wherein, in formula (2): 0<=x<=1; and 0<=y<=2,

LiₓTiNb_{y}O_{z} formula (3),

wherein, in formula (3): 0≤x≤5; 1≤y≤24; and 7≤z≤62,

LiₐTiM_{b}Nb_{c}O_{7+σ} formula (4),

wherein, in formula (4): 0≤a≤5; 0≤b≤0.3; 0≤c≤10; −0.3≤σ≤0.3; and M is at least one element selected from Fe, V, Mo, Ta, Mn, Co or W,

Nb_{α}Ti_{β}O_{7+γ} formula (5),

wherein, in formula (5): 0≤α≤24; 0≤β≤1; and −0.3≤γ≤0.3.

In a second aspect of the present disclosure, the battery module according to the first exemplary embodiment may further include another of the first cell electrically connected in parallel to each of the plurality of the first cells.

In a third aspect of the present disclosure, the battery module according to the first exemplary embodiment may include another of the second cell electrically connected in parallel to each of the second cell.

In a fourth aspect of the present disclosure, the battery module according to the first exemplary embodiment may include a plurality of the second cell electrically connected in series to the plurality of the first cell in an alternating pattern of first cells and second cells.

In a fifth aspect of the present disclosure, the battery module according to the first exemplary embodiment may include a plurality of the second cell electrically connected in series to the plurality of the first cell in an alternating pattern of first cells and second cells, such that none of the first cells in the plurality of the first cells is electrically connected in series to another of the first cell in the plurality of the first cells.

In a sixth aspect of the present disclosure, the battery module according to the fifth aspect may further include another of the first cell electrically connected in parallel to each of the plurality of the first cells, and another of the second cell electrically connected in parallel to each of the plurality of the second cells.

In a seventh aspect of the present disclosure, the battery module according to the first exemplary embodiment may be configured such that at least 51 wt % of the first cell cathode active material is a lithiated phosphate compound when an entire content of the first cell cathode active material is considered 100 wt %, and the lithiated phosphate is a compound according to the following formula (A):

Li₁₊ₓM1ₐX_{b}PO₄ formula (A);

wherein, in formula (A), M1 is at least one selected from Fe, Mn or Co; X is at least one transition metal selected from Ni, V, Y, Mg, Ca, Ba, Al, Sc or Nd; 0≤x≤0.15; a>0; b≥0; and a+b=1.

In an eighth aspect of the present disclosure, the battery module according to the first exemplary embodiment can be configured to balance each of the first cell and the second cell based on its state of charge, such that, when the battery module is balanced, each of the first cell and the second cell reaches the same state of charge.

In a ninth aspect of the present disclosure, the battery module according to eighth aspect may be configured to determine the state of charge based on a voltage of the second cell.

In a tenth aspect of the present disclosure, the battery module according to the ninth aspect may be configured such that at least 51 wt % of the first cell cathode active material is a lithiated phosphate when an entire content of the first cell cathode active material is considered 100 wt %, and the lithiated phosphate is a compound according a compound according to the formula (A) defined above.

In an eleventh aspect of the present disclosure, the battery module according to the tenth aspect may be configured such that the first cell cathode active material further includes a compound according to the following formulas (B) to (D) or a blend thereof:

Li₁₊ₓNiₐM2_{d}O₂ formula (B);

LiMn₂O₄ formula (C);

Li₁₊ₓCoO₂ formula (D);

wherein, in formulas (B) to (D), M2 is at least one selected from Co, Al or Mn; 0≤x≤0.15; a>0; d>0; and a+d=1.

In a twelfth aspect of the present disclosure, the battery module according to the first exemplary embodiment may be configured such that the first cell cathode electrode active material is a compound according to one of the formulas (A) to (D) defined above or a blend thereof.

In a second exemplary embodiment according to the present disclosure, a battery system is provided that includes a first battery module which is the battery module according to the first exemplary embodiment, and a second battery module, the second battery module including a plurality of second battery module cells electrically connected in series. In the second exemplary embodiment, the first battery module is connected in series with the first battery module, each of the second battery module cells includes a second module anode having a second module anode active material, and a second module cathode having a second module cathode active material, at least 60 wt % of the second module anode active material is graphite, Si, SiOx, or a blend thereof when an entire content of the second module anode active material is considered 100 wt %, at least 51 wt % of the second module cathode active material is a lithiated phosphate when an entire content of the second module cathode active material is considered 100 wt %, and the lithiated phosphate is a compound according to the formula (A) defined above.

In fourteenth aspect of the present disclosure, the battery system according to second exemplary embodiment includes a plurality of the second battery module and one and only one of the first battery module.

In a fifteenth aspect of the present disclosure, the battery system according to the fourteenth aspect is configured to determine a state of charge of the battery system based on a voltage of the second cell of the first battery module.

In third exemplary embodiment according to the present disclosure, a battery system is provided that includes a plurality of the battery module according to sixth aspect of the first exemplary embodiment connected in series.

In a fourth exemplary embodiment according to the present disclosure, a method of managing the battery module according to the first exemplary embodiment, which includes a step of balance each of the first cell and the second cell based on its state of charge, such that, when the battery module is balanced, each of the first cell and the second cell reaches the same state of charge.

In an eighteenth aspect of the present disclosure, the fourth exemplary embodiment includes a step of determining the state of charge of the battery module based on a voltage of the second cell.

In a nineteenth aspect of the present disclosure, a method of managing the battery system according to fourteenth aspect is provided, which includes a step of determining a state of charge of the battery system based on a voltage of the second cell of the first battery module.

A person of ordinary skill in the art would understand that all of the above embodiments and aspects thereof can be combined in any manner.

### BRIEF DESCRIPTION OF THE FIGURES

Any figures contained herein are provided only by way of example and not by way of limitation.

FIG. 1 is an electrical schematic for an exemplary 8S:2P battery module.

FIG. 2A is a partial three-dimensional view of a battery module having a plurality of alternating LTO cells and GSi cells.

FIG. 2B is a simple electrical schematic for a 9S:2P battery module.

FIG. 3A is a simple electrical schematic for the 9S:2P battery modules prepared as Sample 1-1 of Example 1, having the overcharged cell marked with a star.

FIG. 3B is a simple electrical schematic for the 8S:2P battery modules prepared as Sample 1-2 of Example 1, having the overcharged cell marked with a star.

FIG. 4 is a cell discharge curve showing voltage versus depth of discharge (DOD) for the GSi cell (graphite/LFP) and LTO cell (LTO/NMC) of Example 3.

FIG. 5 is a battery discharge curve showing voltage versus depth of discharge (DOD) for the cells in Example 3; (1) GSi cells (graphite/LFP) only connected in series; and (2) mixture of GSi cells and LTO cells (LTO/NMC) connected in series.

### DETAILED DESCRIPTION OF EMBODIMENTS OF THE DISCLOSURE

It is to be understood that both the foregoing general description and the following detailed description are exemplary and are intended to provide further explanation of the claims. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Any range will be understood to encompass and be a disclosure of each discrete point and subrange within the range.

(Battery Modules)

The battery modules of the present disclosure include cells having two different types electrochemistry connected in series. The battery modules include a plurality of a first cell, wherein the first cell includes an anode active material of graphite, Si, SiOx, or a blend thereof as a main component (referred to herein below for simplicity as “a GSi cell”), and at least one of a second cell, wherein the second cell includes an anode active material of a lithium titanate oxide or titanate oxide able to be lithiated as a main component (referred to herein below for simplicity as “a LTO cell”).

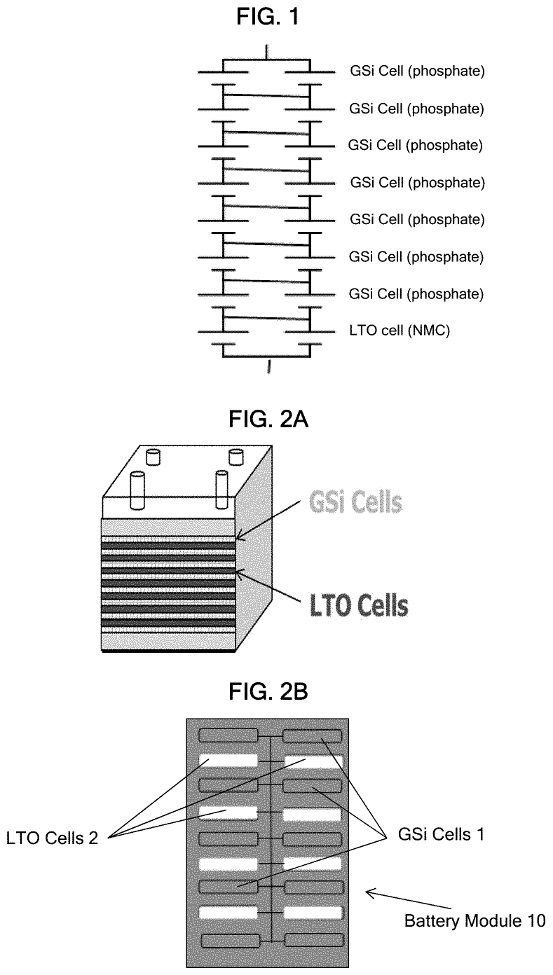

As noted above, the battery modules of the present disclosure include a plurality of the GSi cells and at least one of the LTO cell, wherein the LTO cell is connected in series to one of the GSi cells. This is shown, for example, in FIG. 1. In FIG. 1, the exemplary battery module is shown having a 8S:2P design (i.e., 8 series:2 parallel) that includes in total 14 of the GSi cells (i.e., 7 parallel pairs of GSi cells) and 2 LTO cells (i.e., 1 parallel pair of LTO cells). In FIG. 1, the parallel pair of LTO cells is electrically connected in series to the GSi cells. Of course, other battery module configurations are known and are applicable to the embodiments described herein. For example, the battery module might contain only a plurality of cells in series (that is, a configuration might have no parallel cells).

The battery modules of the present disclosure may also contain a plurality of the LTO cells (when referring, for example, to a 8S:2P design as shown in FIG. 1, a plurality of LTO cells would mean a plurality of parallel LTO pairs). This is shown, for example, in FIGS. 2A and 2B. For example, FIG. 2B shows a battery module 10 having a 9S:2P design in which a plurality of LTO cells 2 (specifically, 8 LTO cells) are electrically connected in series to a plurality of GSi cells 1 (specifically, 10 GSi cells) in an alternating pattern. In one embodiment, when the GSI and LTO cells are connected in an alternating pattern, none of the GSi cells in the plurality of the GSi cells would be connected in series to another of the GSi cells (instead, for example, multiple pairs of GSi cells are connected in parallel, and the GSi pairs are connected in series to LTO pairs).

The battery modules disclosed herein including a plurality of the GSi cells and at least of the LTO cells provide a new battery module design that can address the technical problems explained above and provide one or more of the benefits noted above an explained in more detail below.

(GSi Cells)

Graphite, Si, and SiOx anode materials are well known in the art as being suitable negative electrode active materials for use in lithium ion secondary batteries, and no limitation is placed on the choice of the graphite, Si, and SiOx material for use as the anode active material of the GSi cells of the present disclosure.

In preferred embodiments, the main component of the active material of the GSi cells is graphite, Si, SiOx, or a blend thereof. In particularly preferred embodiments, at least 60 wt % of the active material of the GSi cells is graphite, Si, SiOx, or a blend thereof when an entire content of the active material of the GSi cell is considered to be 100 wt %. Of course, the content of graphite, Si, SiOx, or blend thereof in the active material of the GSi cells can be any weight ratio from 60 wt % up to 100 wt % (100% meaning a reasonably pure material of only graphite, Si, SiOx, or blend thereof), such as 65 wt % or higher, 70 wt % or higher, 75 wt % or higher, . . . 99 wt % or higher, etc. Likewise, when the active material is a blend of graphite and Si, and/or SiOx, the weight ratio of each component is not limited, and can be any weight ratio, such as a 50:50 blend of graphite and SiOx, a 10:90 blend of graphite and SiOx, a 90:10 blend of graphite and SiOx, etc.

When a content of the graphite, Si, SiOx, or blend thereof does not account for 100% of the anode active material of the GSi cells, the minor component of the anode active material can be any other known material suitable for use as a negative electrode active material of a lithium ion secondary battery. An exemplary material includes a lithium titanate oxide or titanate oxide able to be lithiated according to one of the exemplary Formulas (1) to (5) described in more detail below regarding the LTO cells.

The positive active material for the cathode of the GSi cells is not particularly limited, and any known positive electrode active materials for use in a lithium ion secondary battery can be employed. Example positive electrode active materials for use in the GSi cells of the present disclosure include the following compounds according to formulas (A) to (D):

Li₁₊ₓM1ₐX_{b}PO₄ formula (A);

Li₁₊ₓNiₐM2_{d}O₂ formula (B);

LiMn₂O₄ formula (C);

Li₁₊ₓCoO₂ formula (D),

wherein, in formula (A), M1 is at least one selected from Fe, Mn or Co; X is at least one transition metal selected from Ni, V, Y, Mg, Ca, Ba, Al, Sc or Nd; 0≤x≤0.15; a>0; b≥0; and a+b=1, and

wherein, in formula (B), M2 is at least one selected from Co, Al or Mn; 0≤x≤0.15; a>0; d>0; and a+d=1.

Exemplary compounds according to formula (A) include:

compounds according to Formula (A1): Li₁₊ₓFePO₄ (which are known in the art and are referred to herein as “LFP” compounds);

a compound according to Formula (A2): Li₁₊ₓMnPO₄ (which are known in the art and are referred to herein as “LMP” compounds);

a compound according to Formula (A3): Li₁₊ₓCoPO₄ (which are known in the art and are referred to herein as “LCP” compounds);

a compound according to Formula (A4): Li₁₊ₓFe_{y}Mn_{z}PO₄ (which are known in the art and are referred to herein as “LFMP” compounds); and

a compound according to Formula (A5): Li₁₊ₓFe_{y}Mn_{z}X_{b}PO₄ (which are referred to herein as doped LFMP compounds). In the Formulas (A1) to (A5) above, X is at least one transition metal selected from Ni, V, Y, Mg, Ca, Ba, Al, Sc or Nd; 0≤x≤0.15; y>0; z>0; b>0; and y+z+b=1.

The compounds according to formula (B) include, for example:

lithiated oxides of nickel manganese and cobalt according to Formula (B1): Li₁₊ₓNiₐMn_{b}Co_{c}O₂ (which are known in the art and referred to herein as “NMC” compounds);

lithiated oxides of nickel and manganese according to formula (B2): Li₁₊ₓNiₐMn_{b}O₂ (which are known in the art and are referred to herein as “LNMO” compounds); and

lithiated oxides of nickel cobalt and aluminum according to Formula (B3): Li₁₊ₓNiₐCo_{b}Al_{c}O₂ (which are known in the art and are referred to herein as “NCA” compounds). In the Formulas (B1) to (B3) above, a>0; b>0; c>0; and a+b+c=1.

The selection of a positive electrode active material is not particularly limited, except as noted herein below, and the positive electrode active material can be any one of the exemplary materials selected from NMC, LMO, LNMO, NCA, LCO, LFP, LMP, LCP, LMFP, and doped LMFP or blends thereof.

(LTO Cells)

Lithium titanate oxide materials and titanate oxides able to be lithiated materials are well known in the art as being suitable negative electrode active materials for use in lithium ion secondary batteries and no limitation is placed on the choice of the lithium titanate oxide or titanate oxide able to be lithiated for use as the anode active material of the LTO cells of the present disclosure.

In preferred embodiments, the main component of the active material of the LTO cells is lithium titanate oxide, titanate oxide able to be lithiated, or a blend thereof. In particularly preferred embodiments, at least 60 wt % of the active material of the LTO cells is lithium titanate oxide, titanate oxide able to be lithiated, or a blend thereof when an entire content of the LTO cell active material is considered to be 100 wt %. Of course, the content of lithium titanate oxide, titanate oxide able to be lithiated, or blend thereof in the active material can be any weight ratio from 60 wt % up to 100 wt % (100% meaning a reasonably pure material of only lithium titanate oxide, titanate oxide able to be lithiated, or blend thereof), such as 65 wt % or higher, 70 wt % or higher, 75 wt % or higher, . . . 99 wt % or higher, etc.

When a content of the lithium titanate oxide or titanate oxide able to be lithiated does not account for 100% of the anode active material of the LTO cells, the minor component of the anode active material can be any other known material suitable for use as a negative electrode active material of a lithium ion secondary battery, which includes, of course, graphite, Si, SiOx, Sn, and blends thereof.

In preferred embodiments, the lithium titanate oxide or titanate oxide able to be lithiated is a compound according to one of the following Formula (1) to Formula (5) described below or a blend thereof:

Liₓ₋ₐAₐTi_{y-b}B_{b}O_{4-c-d}C_{c} Formula (1),

wherein, in formula (1):
0.5<=x<=3;
1<=y<=2.5;
0<=a<=1;
0<=b<=1;
0<=c<=2;
−2.5<=d<=2.5,
A is at least one selected from the group consisting of Na, K, Mg, Ca, Cu and La;
B is at least one selected from Mo, Mn, Ce, Sn, Zr, Si, W, V, Ta, Sb, Nb, Fe, Co, Ni, Zn, Al, Cr, La, Pr, Bi, Sc, Eu, Sm, Gd, Ti, Ce or Eu; and
C is at least one selected from F or Br,

HₓTiO₄ Formula (2),

wherein, in formula (2):
0<=x<=1; and
0<=y<=2,

LiₓTiNb_{y}O_{z} Formula (3),

wherein, in formula (3):
0≤x≤5;
1≤y≤24; and
7≤z≤62,

LiₐTiM_{b}Nb_{c}O_{7+σ} Formula (4),

wherein, in formula (4):
0≤a≤5;
0≤b≤0.3;
0≤c≤10;
−0.3≤σ≤0.3; and
M is at least one element selected from Fe, V, Mo, Ta, Mn, Co or W,

Nb_{α}Ti_{β}O_{7+γ} Formula (5),

wherein, in formula (5):
0≤α≤24;
0≤β≤1; and

−0.3≤γ≤0.3.

In preferred embodiments, the compound according to Formula (1) is one or more selected from Li₄Ti₅O₁₂, Li₂TiO₃, Li₂Ti₃O₇ and LiTi₂O₄. In other preferred embodiments of Formula (1), a≤0.5; b≤0.25; and/or c≤0.5.

In preferred embodiments, the compound according to Formula (2) is one or more selected from H₂Ti₆O₁₃, H₂Ti₁₂O₂₅ and TiO₂.

The active material for the cathode of the LTO cells is not particularly limited, and any known positive electrode active materials for use in a lithium ion secondary battery can be employed, which includes the positive active materials described above for use in the cathode of the GSi cells. The selection of a positive electrode active material for the LTO is not particularly limited, excepted as noted in herein below, and the positive electrode active material of the LTO cells can be any one of the exemplary materials selected from NMC, LMO, LNMO, NCA, LCO, LFP, LMP, LCP, LMFP, doped LMFP and blends thereof.

(General Structure of the Cells)

The lithium-ion battery cells disclosed herein, i.e., the GSi cells and the LTO cells, have a well-known structure in the art. For example, the cells include a cathode, an anode, an electrolytic solution, and a separator disposed between the anode and the cathode.

(Cathodes)

The general structure of the cathodes for the battery modules disclosed herein is not particularly limited. For example, the positive electrode active material can be disposed on a current collector, and in addition to the active material discussed above, the cathode material can also include one or more binder materials and one or more conductive materials.

The current collector is not particularly limited and known materials and designs can be used. In one embodiment, the current collector is a two-dimensional conducting support such as a solid or perforated sheet, based on carbon or metal, for example in nickel, steel, stainless steel or aluminum.

The use of binder material is not particularly limited and known materials for this function can be used. For example, the binder material may contain one or more of the following components: polyvinylidene fluoride (PVdF) and its copolymers, polytetrafluoroethylene (PTFE), polyacrylonitrile (PAN), polymethyl or polybutyl methacrylate, polyvinyl chloride (PVC), polyvinylformal, polyesters and amide block polyethers, polymers of acrylic acid, methylacrylic acid, acrylamide, itaconic acid, sulfonic acid, elastomers and cellulose compounds.

Among the elastomers which may be used, mention may be made of ethylene/propylene/diene terpolymers (EPDM), styrene/butadiene copolymers (SBR), acrylonitrile/butadiene copolymers (NBR), styrene/butadiene/styrene block copolymers (SBS) or styrene/acrylonitrile/styrene block copolymers (SIS), styrene/ethylene/butylene/styrene copolymers (SEBS), styrene/butadiene/vinylpyridine terpolymers (SBVR), polyurethanes (PU), neoprenes, polyisobutylenes (PIB), butyl rubbers and mixtures thereof.

The cellulose compound may be, for example, a carboxymethylcellulose (CMC), a hydroxypropylmethylcellulose (HPMC), a hydroxypropylcellulose (HPC), a hydroxyethylcellulose (HEC) or other cellulose derivative.

The conductive material is not particularly limited and any known conductive material can be used. For example, the conductive material can be selected from graphite, carbon black, acetylene black (AB), carbon black, soot or one of their mixtures.

Methods of making cathodes are well known. For example, the cathode material can be combined with a binder material and/or a conductive material and applied to a current collector by a known method. For example, granules including the cathode material could be formed and pressed to the current collector by a known method, or a slurry including the cathode material and a solvent could be coated on the current collector and then dried by a known method.

The amounts of a binder, conductive material and other additives are not particularly limited, and suitable ratios are well known in the art. The amount of the conductive material is preferably 1 wt % to 20 wt % (or any amount within this range, e.g., 4 wt % to 18 wt %), and the amount of the binder is preferably 1 wt % to 20 wt % (or any amount within this range, e.g., 1 wt % to 7 wt %), when a total weight of the positive electrode material is considered 100 wt %.

(Anode)

The general structure for the anodes of the GSi cells and LTO cells disclosed herein is not particularly limited, and the structure of graphite, Si, SiOx, and lithium titanate based anodes are well known in the art.

(Electrolytic Solution)

The electrolytic solution can be a known non-aqueous electrolytic solution, which includes a lithium salt dissolved in a solvent.

The lithium salt is not particularly limited and known lithium salts for use in non-aqueous lithium-ion batteries can be used. In preferred embodiments, the electrolyte salt may include one or more of lithium bis(fluorosulfonyl)imide (“LiFSI”), lithium bis(trifluoromethanesulfonyl)imide (“LiTFSI”), LiBF₄, lithium bis(oxalato)borate (“LiBOB”), LiClO₄, LiAsF₆, LiPF₆, LiCF₃SO₃, lithium 4,5-dicyano-2-(trifluoromethyl)imidazole (“LiTDI”), LiPO₂F₂, and the like.

In preferred embodiments, the lithium salt concentration in the electrolytic solution is more than 1.0M, more than 1.2M, more than 1.4M, more than 1.5M, more than 1.6M, more than 1.7M, more than 1.8M, or more than 2.0M. In preferred embodiments, the salt concentration is less than 4.0M, less than 3.6M, less than 3.2M, less than 2.8M, less than 2.4M, less than 2.0M, less than 1.6M, or less than 1.2M.

The solvent is not particularly limited and known solvents for non-aqueous lithium-ion batteries can be used. The solvent can be a single solvent or a mixture of a plurality solvents. The solvent can be selected from usual organic solvents, notably saturated cyclic carbonates, unsaturated cyclic carbonates, non-cyclic (or linear) carbonates, alkyl esters such as formates, acetates, propionates or butyrates, ethers, lactones such as gamma-butyrolactone, tetrahydrothiophene bioxide, nitrile solvents and mixtures thereof. Among such saturated cyclic carbonates, specific mention may be made, for example, of ethylene carbonate (EC), propylene carbonate (PC), butylene carbonate (BC), and mixtures thereof. Among unsaturated cyclic carbonates, specific mention may be made, for example, of vinylene carbonate (VC), its derivatives and mixtures thereof. Among non-cyclic carbonates, specific mention may be made, for example, of dimethyl carbonate (DMC), diethyl carbonate (DEC), ethyl methyl carbonate (EMC), dipropyl carbonate (DPC) and mixtures thereof. Among the alkyl esters, specific mention may be made, for example, of methyl acetate, ethyl acetate, methyl propionate, ethyl propionate, butyl propionate, methyl butyrate, ethyl butyrate, propyl butyrate and mixtures thereof. Among the ethers, mention may for example be made of dimethyl ether (DME) or diethyl ether (DEE), and mixtures thereof. Known fluorinated solvents can also be used, including, for example, fluorinated benzenes (such as hexafluorobenzene, pentafluorobenzene, 1,2,3,4-tetrafluorobenzene, etc.), fluorine substituted linear carbonates, etc.

The electrolytic solution may include a known additive for use in a non-aqueous lithium-ion battery.

One type of additive that may be included in the electrolytic solution is a gas-generation agent used for implementing a pressure-type current interrupt device (CID). Exemplary gas-generation agents include cyclohexylbenzene (CHB), biphenyls, and fluorinated biphenyls having an oxidation potential lower than that of the solvent in the electrolyte solution. When the lithium-ion battery reaches an overcharged state, the compound reacts to generate gas before the electrolyte solution decomposes. When included, the amount of the gas-generation agent is preferably 0.01 wt % to 10 wt % (or any amount within this range, such as, for example, 0.1 wt % to 5 wt %; or 1 wt % to 3 wt %).

Specific mention can also be made to the use of known fluorinated compound additives. For example, the commonly used additive fluorinated ethylene carbonate (FEC) may be included in the electrolytic solution. When included, FEC (and/or another additive) can be added to the solvent in an amount of 0.1 to 10 wt % based on the total weight of the solvent, or can be added in any amount with this range, such as, for example, 1 to 10 wt %, 2 to 9 wt %, 3 to 8 wt %, 4 to 7 wt %, 5 to 6 wt %, 1 to 5 wt %, 1 to 4 wt %, 1 to 3 wt %, 1 to 2 wt %, 2 to 3 wt %, or 0.1 to 1 wt %.

(Separator)

The use of a separator is not particularly limited and known separators for use in non-aqueous lithium-ion batteries can be used. A separator allows Li+ to pass therethrough and prevents electrical contact between the anode and cathode. In one embodiment, the separator is a microporous membrane made of a polyolefin-based material, such as, for example, a microporous membrane made of polyethylene (PE), polypropylene (PP) or the like.

(Cell Structure)

The individual electrochemical cells of the present disclosure can be of any known type, such as cylindrical cell, button cell, prismatic cell and pouch.

(Module and System Structure)

A battery module according to the present disclosure is a device that contains multiple electrochemical cells arranged side by side in a common casing. It is well known and understood how to electrically connect the cells in series and in parallel. Several techniques are disclosed, for example, in the background and in the invention of U.S. Patent Application Publication Nos. 2019/0123315 and 2019/0165584, which are incorporated herein by reference for their disclosure of techniques for assembling a plurality of electrochemical cells and modules.

A battery system according to the present disclosure is a structure that contains multiple of the battery modules according to the present disclosure that are electrically connected to each other.

(Safety)

It was explained above that GSi cells are known to fail abuse tests, such as overcharge, nail penetration, impact, drop, etc. This is because, for example, the graphite/Si/SiOx anode material provides a high voltage (0V vs Li metal) and because fully charged graphite/Si/SiOx can behave like lithium metal (i.e., very reactive). In contrast, it was explained that LTO cells are more stable and show very good abuse stability, and more rarely result in fires.

It was surprisingly and beneficially found that the safety and robustness of battery modules including a plurality of GSi cells can be substantially improved by connecting one or more LTO cells in series with the GSi cells. This result is demonstrated in Examples 1 and 2 below. One reason for this improvement is that each LTO cell can function as a heat insulator to prevent secondary fire events.

In embodiments of the disclosure for promoting safety and robustness, the battery module can be configured to include a LTO cell disposed in series between two GSi cells. The LTO cell may act as a heat insulator and/or as a heat sink, thereby reducing the possibility of fire in response to external forces (e.g., puncture, drop, etc.) or overcharge. In preferred embodiments for promoting safety and robustness, the battery module may include a plurality of the GSi cells connected in series with a plurality of LTO cells. In one embodiment, this can include an alternating arrangement, such as shown in FIG. 2B, wherein each parallel of pair of GSi cells has a parallel pair of LTO series disposed in-between and connected in series thereto.

In other embodiments of the disclosure, a battery system is disclosed that includes multiple of the battery modules configured for safety and robustness.

(State of Charge)

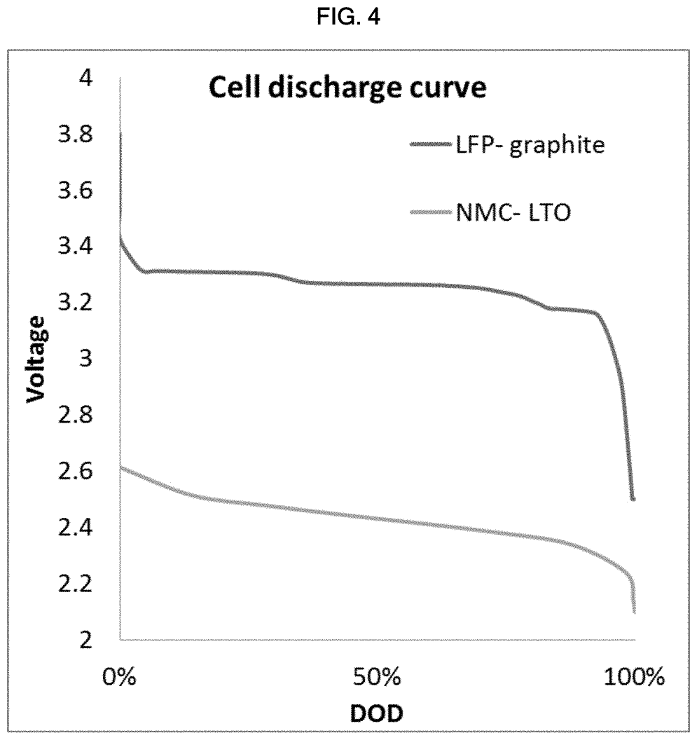

It is well known in the art how to determine the state of charge (SoC) of lithium ion battery cells based on cell voltage, and battery management systems (BMS) configured to determine SoC based on cell voltage are also well known. It was explained above that it can be difficult to determine the SoC of certain electrochemical cell pairs, graphite/phosphate, because they typically have a flat curve of voltage versus SoC. For example, GSi cells in which the cathode material has a lithiated phosphate as a main component (e.g., LFP, LMP, LCP, or a blend thereof) typically have a very flat curve in the range of SoC from 15% to 95%, which can make it very difficult for a battery management system (BMS) to detect the SoC of these cells based on cell voltage. This is shown, for example, by the voltage versus depth of discharge (DOD) curve in FIG. 4, wherein the GSi cell had a graphite/LFP electrochemistry. In contrast, it was recognized that LTO cells, in particular LTO cells having NMC as the main cathode active material, have a sloped curve of voltage versus SoC. This is also shown in FIG. 4, wherein the LTO cells had a LTO/NMC electrochemistry. The same beneficial result (a suitably sloped voltage/DOD curve) can be obtained with other LTO/cathode active material pairs, including LTO paired with LMO, LNMO, NCA, LCO, LFP, LMP, LCP, LMFP, doped LMFP, and blends thereof.

Based on the above, it was surprisingly found that the determination of SoC of battery modules including a plurality of GSi cells can be substantially improved by connecting at least one LTO cell in series with a plurality of GSi cells. By connecting the GSi cells to even a single LTO cell in series, it was found that a BMS can be configured to quickly, easily and accurately determine SoC. Further, it was found that, even if the battery module or battery system is used with an indeterminate small load for an extended time period, the voltage of the LTO cell (which is also referred to herein below as a “pace-keeper” cell) can be used to quickly, easily and accurately determine SoC.

In other embodiments of the disclosure, a battery system is disclosed that includes multiple battery modules (wherein, broadly defined, a battery module is a structure including a multiple battery cells electrically connected to each other) where at least one of the battery modules is a battery module of the present disclosure configured for quickly, easily, and accurately determining SoC (i.e., a battery module including multiple GSi cells and at least one pace-keeper LTO cell).

In another embodiment, the battery system described above that includes multiple of the battery modules configured for safety and robustness may additionally include one battery module configured for quickly, easily and accurately determining SoC (i.e., a multi-GSi cell battery module having at least one pace-keeper LTO cell).

The battery system according to the present disclosure can include many modules in series, such as in high voltage batteries. For instance, the battery system may include 22 battery modules, each module having 12 cells in series (only one in parallel), for a total battery voltage of 1000V. In such a system, either one cell per module or one cell per system could be a pace-keeper LTO cell and all the others cells could be a GSi cell having, e.g., a graphite/lithiated phosphate electrochemistry. For example, in the latter case, 275 of the GSi cells could be placed in series with a single LTO cell, and the single pace-keeper LTO cell would be sufficient to easily determine the SoC of the battery system. Note that in this exemplary embodiment, one of the 22 modules would be different from the other 21.

According to these embodiments, the control logic, software, or firmware of the battery modulesystem can be configured to balance each cell based on its SoC rather than its voltage, such that when the battery is balanced, each electrochemical unit reaches the same SoC. Furthermore, after the balancing described above, the LTO cell provides the signal by which the SoC of the battery is determined. Methods of cell monitoring and balancing are well known in the art. For example, such methods are discussed in U.S. Patent Publication Nos. 2010/0253277 and 2015/0115736, which are incorporated by reference herein for their discussion of cell monitoring and balancing, including hardware and programming for accomplishing this function.

In another embodiment, the battery system described above including multiple battery modules configured for safety and robustness, can have a plurality of the LTO cells further configured as pace-keeper cells. In other words, described is a battery system including multiple battery modules configured for both safety and robustness and quickly, easily and accurately determining SoC.

In another embodiment, it is understood that the battery modules and/or battery systems of the present disclosure may additionally include a known BMS, which is configured, for example, with known programing (e.g., algorithms) for determining SoC. Alternatively, the battery modules and battery systems of the present disclosure may be configured to be operated and/or monitored by an external BMS.

The SoC algorithm for a module consisting of a plurality of GSi cells can be modified to accommodate and leverage the cell stability and better defined SoC curve obtained by the addition of a single LTO cell (or LTO cell parallel pair). Conventional SoC algorithms for a module consisting of a plurality of GSi cells might use multiple methods to work around issues derived from the flat voltage curve and to correct for error accumulated by use of a coulomb counting (CC) algorithm. However, the addition of a single LTO cell (or LTO pair) can provide improved accuracy of the reported SoC by deriving the SoC of the GSi cells from the monitoring of the LTO cell (e.g., frequent open circuit voltage (OCV) table lookups on the LTO cell (or LTO pair)).

### EXAMPLES

In the following, although embodiments of the present disclosure are described in further detail by means of Examples, the present disclosure is not limited thereto.

### Example 1

### Overcharge Safety

Battery modules were prepared for conducting a battery overcharging test.

(Sample 1-1)

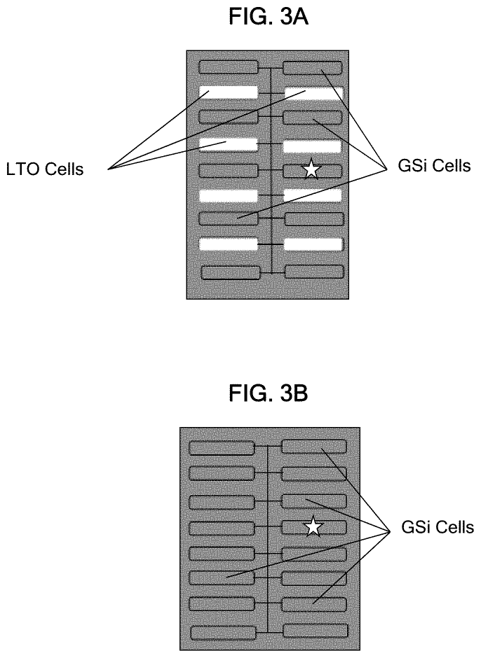

For Sample 1-1, a combination of GSi cells and LTO cells was used. The GSi cells were 40 Ah graphite/NMC pouch cells, and the LTO cells were 40 Ahr LTO/NMC pouch cells. See Table 1 below for composition specifics. The battery capacity was 80 Ah, and the max voltage was 32V. As shown in FIG. 3A, the GSi cells and the LTO cells were overlaid alternately as a 9S:2P battery back to form the battery module of Sample 1-1. For the overcharging test, a GSi cell located in the middle of battery (marked with a star in FIG. 3A) was overcharged. All of the other GSi and LTO cells were fully charged during the overcharge test.

TABLE 1

| Cell | Anode | Cathode |
|---|---|---|
| GSi | graphite | LiNi_{1/3}Co_{1/3}Mn_{1/3}O₂ |
| LTO | Li₄Ti₅O₁₂ | LiNi_{1/3}Co_{1/3}Mn_{1/3}O₂ |

(Comparative Sample 1-2)

For Comparative Sample 1-2, only GSi cells were used. The GSi cells were 40 Ah graphite/NMC pouch cells to achieve a battery capacity of 80 Ah and a max voltage of 32V. The composition of the GSi cells was the same as the GSi cells used in Sample 1-1. As shown in FIG. 3B, the GSi cells were overlaid alternately as a 8S:2P battery back to form the battery module of Sample 1-2. For the overcharging test, one GSi cell located in the middle of battery (marked with a star in FIG. 3B) was overcharged. All of the other GSi cells were fully charged during the overcharge test.

10 of the battery pack modules were prepared for Sample 1-1, and 10 of the battery pack modules were prepared for Comparative Sample 1-2, and then then the overcharge test was performed on each of the battery modules.

The results in Table 2 below show a clear improvement for the battery modules of Sample 1-1 as compared to the battery modules of Comparative Sample 1-2. For example, in each of the 10 modules of Sample 1-1, the overcharged GSi cell heated up and caused leakage and rupture. However, the heat was rejected and/or absorbed by a heat sink function and the other GSi cells did not heat up. The GSi cell connected in parallel to the overcharged cell experienced an increase in heat, but the adjacent LTO cells were not only acting as an insulator but also acting as a heat sink.

In contrast, in each of the 10 modules of Comparative Sample 1-2, the overcharged cell substantially heated up the adjacent GSi cells. Further, once multiple GSi cells heated up, a large amount of heat could not be safely dissipated and chain reactions of cell rupture, fire, and sometimes explosion occurred as indicated in Table 2 below. In other words, when graphite cells adjacent to the overcharged cells were overheated, a chain reaction (possibly explosion) occurred.

TABLE 2

| | Eucar4 | Eucar5 | Eucar6 | |
|---|---|---|---|---|
| | Leakage/ | Pouch | Fire or | Eucar7 |
| | venting | Rupture | flame | Explosion |
| Sample 1-1 | 4/10 | 6/10 | | |
| (GSi-LTO) | | | | |
| Comparative | | 1/10 | 7/10 | 2/10 |
| Sample 1-2 | | | | |
| (GSi only) | | | | |

### Example 2

### Overheat Safety

For Example 2, battery modules were prepared for conducting a battery overheating test.

(Sample 2-1)

For Sample 2-1, the GSi cells were 5 Ah SiOx/Graphite (50/50) blend/NMC pouch cells, and the LTO cells were 5 Ahr LTO/NMC pouch cells. See Table 3 for composition specifics. The GSi cells and LTO cells were overlaid alternately and connected as a 9S:1P battery pack to form the battery module of Sample 2-1. Battery capacity was 5 Ah, and the max battery voltage was 32V. For the overheating test, one of the GSi cells located in the middle of battery was overheated. Specifically, the GSi cell was heated to 100° C., and then heated at a temperature increase of 5° C./min until the GSi cell began thermal runaway. All the other cells were fully charged state during overcharge test.

TABLE 3

| Cell | Anode | Cathode |
|---|---|---|
| GSi | SiOx/Graphite | LiNi_{1/3}Co_{1/3}Mn_{1/3}O₂ |
| | (50/40) | |
| LTO | Li₄Ti₅O₁₂ | LiNi_{1/3}Co_{1/3}Mn_{1/3}O₂ |

(Comparative Sample 2-2)

For Comparative Sample 2-2, only GSi cells were used. The GSi cells were the same as the SiOx/Graphite (50/50) blend/NMC pouch cells used in Sample 2-1. The GSi cells were connected as a 8S:1P battery pack to form the battery module of Sample 2-2. The battery pack capacity and max battery voltage was same as sample 2-1, i.e., 5 Ah and 32V, respectively. For the overheating test, one cell located in the middle of battery was overheated. This cell was heated to 100° C., and then heated at a temperature increase of 5° C./min until the GSi cell began thermal runaway. All the other cells were fully charged state during overcharge test.

10 of the battery pack modules were prepared for Sample 2-1, and 10 of the battery pack modules were prepared for Comparative Sample 2-2, and then then the overheating test was performed on each of the battery modules.

The results Table 4 below shows clear improvement for the battery modules of Sample 2-1 as compared to the battery modules of Comparative Sample 2-2. This is because the heat dissipation of Sample 2-1's overheated cell was blocked by the LTO cells

TABLE 4

| | Eucar4 | Eucar5 | Eucar6 | |
|---|---|---|---|---|
| | Leakage/ | Pouch | Fire or | Eucar7 |
| | venting | Rupture | flame | Explosion |
| Sample 2-1 | | 1/10 | 9/10 | |
| GSi-LTO | | | | |
| Comparative | | | | 10/10 |
| Sample 2-2 | | | | |
| GSi only | | | | |

### Example 3

### SoC

As discussed above, certain graphite cell electrochemistries provide a very flat voltage versus depth of discharge curve (DOD). In particular, graphite/lithiated phosphate pairs show very flat voltage vs. DOD curves, which makes it difficult, if not impossible, for BMS to detect stage of charge (SoC) by voltage. This is shown, for example, in FIG. 4. To create the GSi curve in FIG. 4, a GSi cell was prepared wherein the anode active material was graphite, and the cathode active material was LiFePO₄. During the test, the battery was discharged at a constant rate (0.1 C) at a temperature of about 25° C.

In contrast, LTO cells can provide a sloped voltage versus DOD curve. This is shown in FIG. 4, wherein there are no flat areas on the curve for the LTO cell. To create the LTO curve in FIG. 4, a LTO cell was prepared wherein the anode active material was LTO (Li₄Ti₅O₁₂) and the cathode active material was 100 wt % NMC (LiNi_{1/3}Co_{1/3}Mn_{1/3}O₂). The LTO cell was discharged in the same manner discussed above for the GSi cell.

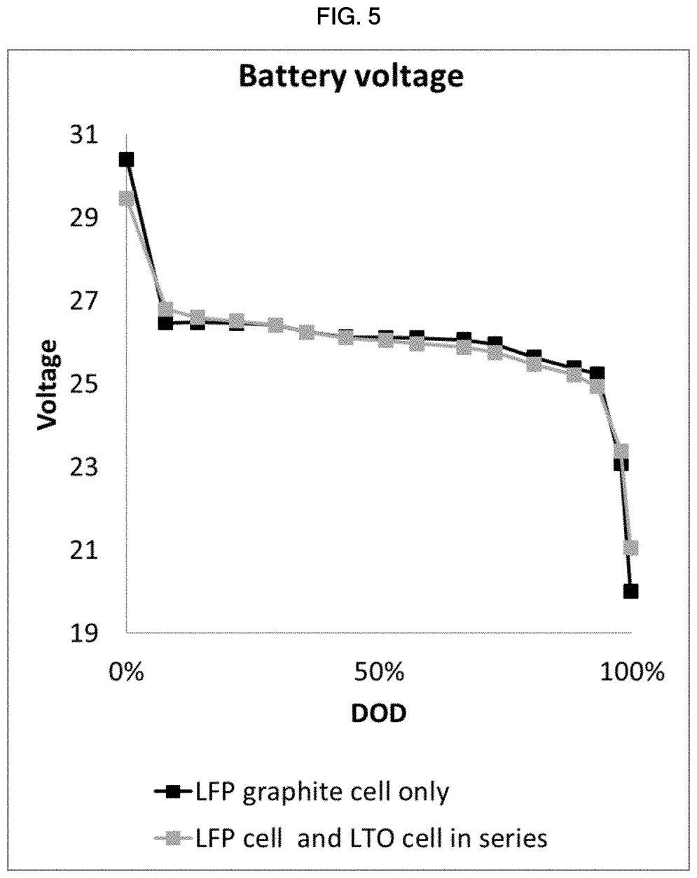

In addition, FIG. 5 provides the cell discharge curve results obtained for the LTO cell alone in comparison to when the LTO cell is connected in series to the GSi cell. FIG. 5 shows that, by connecting these two types of cells in series, the SoC of the GSi cells can be easily detected. Accordingly, as a whole battery module, the battery discharge curve is not as flat as when only graphite/phosphate cells are used. The slightly sloped discharge curve at the battery level will assist in naturally balancing the SoC between parallel-connected batteries.

The disclosure is susceptible to various modifications and alternative means, and specific examples thereof are herein described in detail. It should be understood, however, that the disclosure is not to be limited to the particular examples or methods disclosed, but to the contrary, the disclosure is to cover all modifications, equivalents, and alternatives falling within the spirit and scope of the claims.

1. A battery module, comprising:
a first cell comprising a first cell anode having a first cell anode active material, and a first cell cathode having a first cell cathode active material, wherein at least 60 wt % of the first cell anode active material is graphite, silicon, SiOx, or a blend thereof when an entire content of the first cell anode active material is considered 100 wt %; and
a second cell comprising a second cell anode having a second cell anode active material, and a second cell cathode having a second cell cathode active material, wherein at least 60 wt % of the second cell anode active material is a lithium titanate oxide or titanate oxide able to be lithiated when an entire content of the second cell anode active material is considered 100 wt %,
wherein the battery module includes a plurality of the first cell and at least one of the second cell, and
the at least one second cell is electrically connected in series to the plurality of the first cell.

2. The battery module according to claim 1, wherein
the lithium titanate oxide or titanate oxide able to be lithiated is a compound according to one of the following formulas (1) to (5) or a blend thereof:
Liₓ₋ₐAₐTi_{y-b}B_{b}O_{4-c-d}C_{c} formula (1),
wherein, in formula (1):
0.5<=x<=3;
1<=y<=2.5;
0<=a<=1;
0<=b<=1;
0<=c<=2;
−2.5<=d<=2.5,
A is at least one selected from the group consisting of Na, K, Mg, Ca, Cu and La;
B is at least one selected from the group consisting of Mo, Mn, Ce, Sn, Zr, Si, W, V, Ta, Sb, Nb, Fe, Co, Ni, Zn, Al, Cr, La, Pr, Bi, Sc, Eu, Sm, Gd, Ti, Ce and Eu; and
C is at least one selected from the group consisting of F, S and Br,
HₓTiO₄ formula (2),
wherein, in formula (2):
0<=x<=1; and
0<=y<=2,
LiₓTiNb_{y}O_{z} formula (3),
wherein, in formula (3):
0≤x≤5;
1≤y≤24; and
7≤z≤62,
LiₐTiM_{b}Nb_{c}O_{7+σ} formula (4),
wherein, in formula (4):
0≤a≤5;
0≤b≤0.3;
0≤c≤10;
−0.3≤σ≤0.3; and
M is at least one element selected from the group consisting of Fe, V, Mo, Ta, Mn, Co and W,
Nb_{α}Ti_{β}O_{7+γ} formula (5),
wherein, in formula (5):
0≤α≤24;
0≤β≤1; and
−0.3≤γ≤0.3.

3. The battery module according to claim 1, further comprising:
another of the first cell electrically connected in parallel to each of the plurality of the first cells.

4. The battery module according to claim 1, further comprising:
another of the second cell electrically connected in parallel to each of the second cell.

5. The battery module according to claim 1, further comprising:
a plurality of the second cell electrically connected in series to the plurality of the first cell in an alternating pattern of first cells and second cells.

6. The battery module according to claim 1, further comprising:
a plurality of the second cell electrically connected in series to the plurality of the first cell in an alternating pattern of first cells and second cells, such that none of the first cells in the plurality of the first cells is electrically connected in series to another of the first cell in the plurality of the first cells.

7. The battery module according to claim 6, further comprising:
another of the first cell electrically connected in parallel to each of the plurality of the first cells, and
another of the second cell electrically connected in parallel to each of the plurality of the second cells.

8. The battery module according to claim 1, wherein:
at least 51 wt % of the first cell cathode active material is a lithiated phosphate compound when an entire content of the first cell cathode active material is considered 100 wt %, and
the lithiated phosphate is a compound according to the following formula (A):
Li₁₊ₓM1ₐX_{b}PO₄ formula (A);
wherein, in formula (A), M1 is at least one selected from the group consisting of Fe, Mn and Co; X is at least one transition metal selected from the group consisting of Ni, V, Y, Mg, Ca, Ba, Al, Sc and Nd; 0≤x≤0.15; a>0; b≥0; and a+b=1.

9. The battery module according to claim 1, wherein:
the battery module is configured to balance each of the first cell and the second cell based on its state of charge, such that, when the battery module is balanced, each of the first cell and the second cell reaches the same state of charge.

10. The battery module according to claim 9, wherein:
the battery module is configured to determine the state of charge based on a voltage of the second cell.

11. The battery module according to claim 10, wherein:
at least 51 wt % of the first cell cathode active material is a lithiated phosphate when an entire content of the first cell cathode active material is considered 100 wt %, and
the lithiated phosphate is a compound according to the following formula (A):
Li₁₊ₓM1ₐX_{b}PO₄ formula (A);
wherein, in formula (A), M1 is at least one selected from the group consisting of Fe, Mn and Co; X is at least one transition metal selected from the group consisting of Ni, V, Y, Mg, Ca, Ba, Al, Sc and Nd; 0≤x≤0.15; a>0; b≥0; and a+b=1.

12. The battery module according to claim 11, wherein:
the first cell cathode active material further comprises a compound according to one of the following formulas (B) to (D) or a blend thereof:
Li₁₊ₓNiₐM2_{d}O₂ formula (B);
LiMn₂O₄ formula (C);
Li₁₊ₓCoO₂ formula (D);
wherein, in formulas (B) to (D), M2 is at least one selected from the group consisting of Al and Mn; 0≤x≤0.15; a>0; d>0; and a+d=1.

13. The battery module according to claim 1, wherein:
the first cell cathode electrode active material is a compound according to one of the following formulas (A) to (D) or a blend thereof:
Li₁₊ₓM1ₐX_{b}PO₄ formula (A);
Li₁₊ₓNiₐM2_{d}O₂ formula (B);
LiMn₂O₄ formula (C);
Li₁₊ₓCoO₂ formula (D);
wherein, in formula (A), M1 is at least one selected from the group consisting of Fe, Mn and Co; X is at least one transition metal selected from the group consisting of Ni, V, Y, Mg, Ca, Ba, Al, Sc and Nd; 0≤x≤0.15; a>0; b≥0; and a+b=1, and
wherein, in formulas (B) to (D), M2 is at least one selected from the group consisting of Al and Mn; X is at least one transition metal selected from the group consisting of Ni, V, Y, Mg, Ca, Ba, Al, Sc and Nd; 0≤x≤0.15; a>0; d>0; and a+d=1

14. A battery system, comprising:
a first battery module which is the battery module according to claim 1; and
a second battery module, the second battery module comprising a plurality of second battery module cells electrically connected in series,
wherein
the first battery module is connected in series with the second battery module,
each of the second battery module cells comprises a second module anode having a second module anode active material, and a second module cathode having a second module cathode active material,
at least 60 wt % of the second module anode active material is graphite, Si, SiOx, or a blend thereof when an entire content of the second module anode active material is considered 100 wt %,
at least 51 wt % of the second module cathode active material is a lithiated phosphate when an entire content of the second module cathode active material is considered 100 wt %, and
the lithiated phosphate is a compound according to the following formula (A):
Li₁₊ₓM1ₐX_{b}PO₄ formula (A);
wherein, in formula (A), M1 is at least one selected from the group consisting of Fe, Mn and Co; X is at least one transition metal selected from the group consisting of Ni, V, Y, Mg, Ca, Ba, Al, Sc and Nd; 0≤x≤0.15; a>0; b≥0; and a+b=1.

15. The battery system according to claim 14, wherein the battery system comprises a plurality of the second battery module and one and only one of the first battery module.

16. The battery system according to claim 15, wherein the battery system is configured to determine a state of charge of the battery system based on a voltage of the second cell of the first battery module.

17. A battery system, comprising:
a plurality of the battery module according to claim 7 connected in series.

18. A method of managing the battery module according to claim 1, comprising a step of acting to balance each of the first cell and the second cell based on its state of charge, such that, when the battery module is balanced, each of the first cell and the second cell reaches the same state of charge.

19. A method of managing the battery module according to claim 1, comprising a step of determining the state of charge of the battery module based on a voltage of the second cell.

20. A method of managing the battery system according to claim 15, comprising a step of determining a state of charge of the battery system based on a voltage of the second cell of the first battery module.
